(19) United States
(12) Patent Application Publication
(10) Pub. No.: US 2012/0130735 A1
(43) Pub. Date: May 24, 2012

(54) DRUG, TEST AND DEVICE CENTRIC CLINICAL DECISION SUPPORT, ANALYTIC AND COMMUNICATION SYSTEM

(76) Inventor: Shraga Rottem, Forest Hills, NY (US)

(21) Appl. No.: 13/301,271

(22) Filed: Nov. 21, 2011

Related U.S. Application Data
(60) Provisional application No. 61/415,677, filed on Nov. 19, 2010.

(51) Int. Cl. G06Q 50/22

(52) U.S. Cl. 705/2

(57) ABSTRACT

Disclosed is a system for communicating information relating to the utilization of drugs, tests and devices to diagnose and treat disease which comprises a user interface, a data processor, a hard drive, a modem, a first module for screening clinical and laboratory data relating to a patient to rank a drug, test, and/or device used by a user. The system further comprises a second module for notifying a user of a patient's response to that employed in said first module and a third module for re-evaluating a patient's response to the drug, test, and/or device, employed in the first module. Additionally, a fourth module can automatically select a relevant database related to the use of the drug, test, and/or device, and for ranking a patient's response to the third module; and a fifth module for collecting and storing a patient's data from the first, second, third and fourth modules.

### CROSS-REFERENCE TO RELATED APPLICATIONS

This application claims priority of U.S. Provisional Application 61/415,677, filed Nov. 19, 2010, the disclosure of which is expressly incorporated by reference herein in its entirety.

### FIELD OF THE INVENTION

The present invention relates to the fields of diagnosis and treatment of disease, and in particular, an improved computer system and apparatus for guiding the administration, by a user, of a drug, test, device or any combination thereof, to achieve a particular outcome.

### BACKGROUND OF THE DESCRIPTION

The outcome of the diagnosis and treatment of diseases depends on many factors including but not limited to the patient, timing and methods of diagnosis, as well as the treatments that are employed in each case.

While other patents disclose certain features regarding the treatment and diagnosis of disease using computerized systems, the present invention focuses on a much more comprehensive system than previous patents that takes into consideration drugs, tests, devices or any combination thereof, in an effort to improve the safety of using such mechanisms as well as to improve patient outcome when such mechanisms are used.

### SUMMARY OF THE DISCLOSURE

The present invention provides a system that automatically provides a user with guidance on the best way to employ a drug, test, device or any combination thereof, to secure the best possible outcome for a patient. The “best” outcome can be a function of the suspected or existing disease or as a function of a particular screening method.

The present invention further provides an automatic real-time communication system for professionals that prescribes or indicates the need for a particular drug, test, device or any combination thereof, for a respective patient.

Additionally, the present invention analyzes weighted data relating to the use of a drug, test, device or any combination thereof, with respect to patient data and outcome data, inter alia.

Even further, the present invention automatically provides a user with guidance so that they may improve upon the usability and formula of a drug, biological agent, or the like; the components of a screening or diagnostic test and their usability; and the features and calibration of a device, accordingly.

### BRIEF DESCRIPTION OF THE DRAWINGS

FIG. 1 is a flow diagram depicting the five (5) different modules of the present invention.

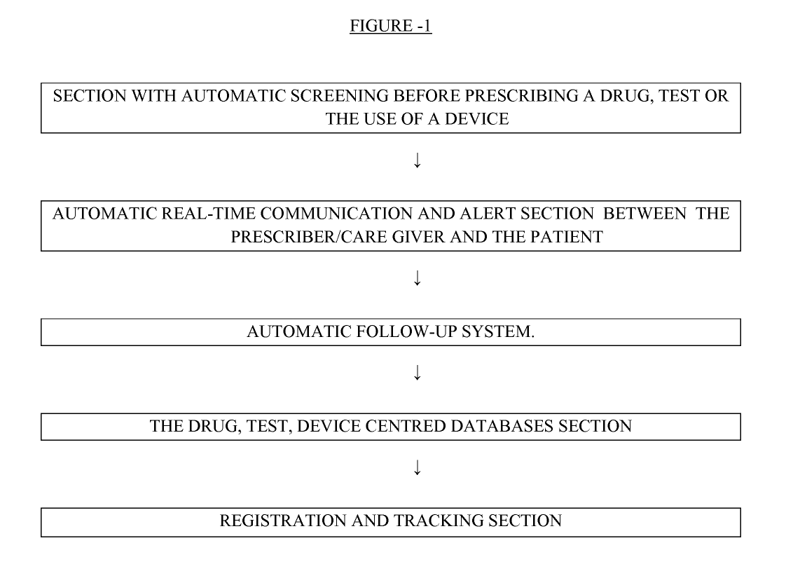

### DETAILED DESCRIPTION OF THE INVENTION

The system and apparatus of the present invention includes five sections/modules.

A first section automatically screens for clinical and lab values of a case which may, for example, contra-indicate the use of a particular drug, test or device in a given case.

The first section further automatically ranks the best choice of a drug, test or device tailored to a given case.

The first section also conducts screening, which can be electronic from existing patient data and/or combined with a training system guiding professionals on the best use of a drug or test, inter alia, in each given case.

The training system can provide examples of normal and abnormal images, as well as examples of data with weighted differential diagnosis (by probability), such as if a distributed or as embedded system working inside the medical device.

Accordingly, the system described above will automatically adjust to other drugs, tests, devices or any combination thereof, already is use by a patient, for example.

A second section automatically notifies the professional as to the progress of treatment and the potential or final outcome.

Further, the second section automatically alerts a user as to problems related to a drug/therapy, inter alia, which requires a change in the treatment, dose, therapy, or the like.

Even further, the second section automatically collects data on each given drug or combination of drugs; test or tests; and on the use of a device. Additionally, data is collected on the inter-relation of the use of drugs, tests, devices or any combination thereof, in a large number of patients.

A third system of the present invention reevaluates the new data after the use of a given drug, test, device or any combination thereof.

Further the third system automatically corrects of the screening or diagnostic choice or treatment initially thought, should such reevaluation warrant such a change.

A fourth system automatically selects at least one of the databases related to the use of a drug, test or treatment for manual or computer based consultation by the practitioner and processed hyperlink relevant to the case and data as described above.

The databases can be electronic and include a weighted probability of participation for prescribing or making changes based on follow-up procedures described herein, inter alia.

Alternatively, the databases can be printed material bundled with a prescription pad used by the practitioner for a drug or test, inter alia.

Further, each prescription pad and the at least one database can have a unique scan bar. Once the scan bar is detected by a mobile phone and/or other electronic device, it will link only such authorized registered professionals to the desired site, database, information, or the like, based upon the access provided by the unique scan bar.

The fifth system of the present invention collects anonymous data on the professionals accessing it and tracking the use of various functions in each of described above by each professional.

Further, the fifth system analyzes professionals' choices of screening, diagnosis and therapy. The user can then base criteria, when prescribing a drug or test for a patient, by considering factors including dose, timing, side effects, the decision to stop or change dose or prescribe alternative therapy in coordination with known patient data.

Even further, the fifth system gives real-time access to analysis of the data collected as described above to practitioners using a certain drug, test, device, etc., if they are registered accordingly.

Further, the fifth system also gives the same type of access to a user developing, marketing or distributing such a drug, test, device or any combination thereof.

It is acknowledged that each section of the present invention can interrelate with one or more sections or can exist on its own.

It is to be understood that even though numerous characteristics and advantages of various embodiments of the present invention have been set forth in the foregoing description together with details of the structure and function of various embodiments of the present invention, this disclosure is illustrative only, and changes may be made in detail, especially in matters of structure and arrangement of parts within the principles of the present invention to the full extent indicated by the broad general meaning of the terms.

What is claimed is:

1. A computerized system for communicating information relating to the utilization of drugs, tests and devices to diagnose and treat disease, the system comprising:
a user interface, a data processor, a hard drive, and a modem;
a first module for automatically screening clinical and laboratory data relating to at least one patient to rank a drug, test, device or any combination thereof, to be employed by said user;
a second module for automatically notifying said user of the at least one patient's response to that employed in said first module;
a third module for automatically re-evaluating said patient's response to the drug, test, device or any combination thereof, employed by said user in said first module;
a fourth module for automatically selecting at least one relevant database related to the use of the drug, test, device or any combination thereof, and for ranking said at least one patient's response to said third module; and
a fifth module for collecting and storing said at least one patient's data from said first, second, third and fourth modules.

2. A computerized system as claimed in claim 1, wherein the at least one relevant database comprises printed material, electronic material, audio material, written material, written prescriptions, or any combination thereof.

3. A computerized system as claimed in claim 2, wherein the printed material, electronic material, audio material, written material, written prescriptions, or any combination thereof, has a unique scan bar, bar code, or other computer-readable medium linked thereto.

4. A computerized system as claimed in claim 3, wherein the unique scan bar, bar code, or computer-readable medium is capable of being scanned by mobile phones, multi-media devices, personal digital assistants, or other electronic devices.

5. A computerized system as claimed in claim 4, wherein the information contained within the unique scan bar, bar code or other computer-readable medium restricts access to a desired site, database, information, or any combination thereof, based upon the user's pre-determined authorization status.

6. A computerized system as claimed in claim 5, wherein the at least one relevant database links to at least one additional database based upon user preference.

7. A data storage unit comprising a set of computer instructions, the set of computer instructions comprising:
computer instructions for automatically screening clinical and laboratory data relating to at least one patient to rank a drug, a test, a device or any combination thereof, to be employed by said user;
computer instructions for automatically notifying said user of the at least one patient's response to said first module;
computer instructions for automatically re-evaluating said patient's response to the drug, test, device or any combination thereof, employed by said user in said first module;
computer instructions for automatically selecting at least one relevant database related to the use of the drug, test, device or any combination thereof, for ranking said at least one patient's response to said third module; and
computer instructions for collecting and storing said at least one patient's data from said first, second, third and fourth modules.
